(19) United States
(12) Patent Application Publication
(10) Pub. No.: US 2025/0116789 A1
(43) Pub. Date: Apr. 10, 2025

(54) SYSTEM AND METHOD FOR DISTRIBUTED ACOUSTIC SENSING VERTICAL SEISMIC PROFILE MODELING

(71) Applicant: Chevron U.S.A. Inc., San Ramon, CA (US)

(72) Inventor: Chunling Wu, Houston, TX (US)

(21) Appl. No.: 18/482,821

(22) Filed: Oct. 6, 2023

(51) Int. Cl. G01V 1/32; G01V 1/22

(52) U.S. Cl. CPC G01V 1/325; G01V 1/226; G01V 2210/161

(57) ABSTRACT

A method is described for generating distributed acoustic sensing (DAS) vertical seismic profile (VSP) data including receiving, at one or more processing cores, synthetic DAS acquisition parameters; modeling synthetic pressure-field data; augmenting the synthetic pressure-field data using reciprocity to generate an augmented dataset; sorting the augmented dataset into pressure-field common shot gathers; and converting the pressure-field common shot gathers to strain-rate DAS VSP data. The converting may be done by taking a spatial derivative of pressure along a DAS cable; performing a temporal integral to find particle velocity along the DAS cable; and taking a spatial derivative of the partial velocity along the DAS cable to convert the pressure-field common shot gathers to strain-rate DAS VSP data.

### TECHNICAL FIELD

The disclosed embodiments relate generally to techniques for using distributed acoustic sensing (DAS) for acquiring borehole seismic data for reservoir characterization. In particular, the embodiments relate to improved modeling of DAS data in vertical seismic profiles in order to design DAS survey acquisition parameters.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

An alternative seismic sensor may include fiber-optic cables. Fiber-optic cables may be deployed in a borehole drilled through the earth's subsurface, along the earth's surface, or on a seabed. FIG. 1 illustrates a fiber-optic cable 12 attached to an interrogator 10. A laser pulse 14 propagates through the fiber-optic cable 12, shown as light stream 16. The light stream 16 sends information to interrogator 10. An acoustic signal 18 encountering the fiber-optic cable 12 is recorded as a change in strain or strain-rate along the cable and may be considered to be a seismic event. However, conventional methods for modeling and processing seismic data are designed for pressure or particle motion data, so may not produce accurate results when processing the DAS seismic data which is a measurement of strain or strain-rate.

Distributed acoustic sensing (DAS) is an emerging technology for acquiring borehole seismic data for reservoir characterization. Recently, there are more DAS vertical seismic profile (VSP) data acquired and planned to be acquired in areas such as the Gulf of Mexico for 4D study. Forward modeling can provide crucial guidance on acquisition design of the DAS experiments and in the later phases of processing and data interpretation. The efficient way for VSP modeling is using reciprocity since there are much more shots than receivers in VSP surveys, e.g., ˜740,000 shots vs. ˜2000 receivers. However, unlike conventional VSP with a vector of velocity measurement, DAS seismic measures strain or strain-rate (a second order tensor) along the DAS cable. Implementing strain or strain-rate as a reciprocal source is not straight forward, therefore most of DAS VSP field acquisition modeling study doesn't use exact the DAS measurement of strain or strain-rate but use a different component such as pressure which does not truly represent DAS measurement.

There exists a need for methods of modeling DAS VSP for determining acquisition parameters that can then be used in real field surveys.

### SUMMARY

In accordance with some embodiments, a method of generating distributed acoustic sensing (DAS) vertical seismic profile (VSP) data including receiving, at one or more processing cores, synthetic DAS acquisition parameters; modeling synthetic pressure-field data; augmenting the synthetic pressure-field data using reciprocity to generate an augmented dataset; sorting the augmented dataset into pressure-field common shot gathers; and converting the pressure-field common shot gathers to strain-rate DAS VSP data is disclosed. In an embodiment the converting comprises taking a spatial derivative of pressure along a DAS cable; performing a temporal integral to find particle velocity along the DAS cable; and taking a spatial derivative of the partial velocity along the DAS cable to convert the pressure-field common shot gathers to strain-rate DAS VSP data.

In another aspect of the present invention, to address the aforementioned problems, some embodiments provide a non-transitory computer readable storage medium storing one or more programs. The one or more programs comprise instructions, which when executed by a computer system with one or more processing cores and memory, cause the computer system to perform any of the methods provided herein.

In yet another aspect of the present invention, to address the aforementioned problems, some embodiments provide a computer system. The computer system includes one or more processing cores, memory, and one or more programs. The one or more programs are stored in memory and configured to be executed by the one or more processing cores. The one or more programs include an operating system and instructions that when executed by the one or more processing cores cause the computer system to perform any of the methods provided herein.

### BRIEF DESCRIPTION OF THE DRAWINGS

FIG. 1 illustrates a distributed acoustic sensing (DAS) seismic recording system;

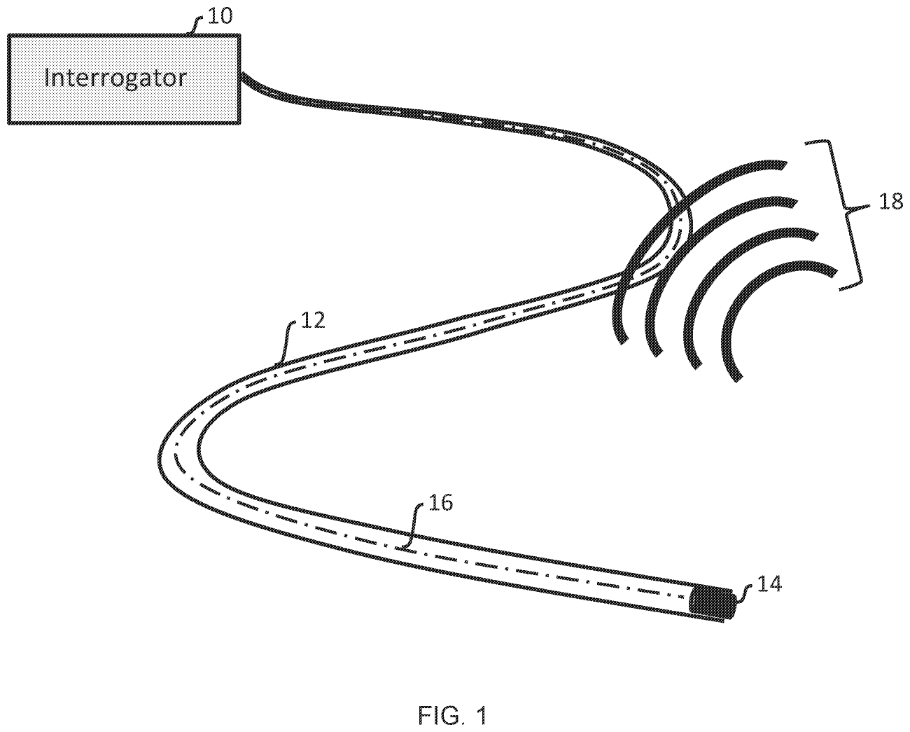

FIG. 2 illustrates an example system for modeling DAS VSP for determining acquisition parameters;

FIG. 3 illustrates an example method for modeling DAS VSP for determining acquisition parameters; and

FIG. 4 illustrates steps in modeling DAS VSP for determining acquisition parameters.

Like reference numerals refer to corresponding parts throughout the drawings.

### DETAILED DESCRIPTION OF EMBODIMENTS

Described below are methods, systems, and computer readable storage media that provide a manner of modeling DAS VSP for determining acquisition parameters. The method converts pressure field to strain-rate field for a DAS cable installed in a fluid filled borehole and builds a workflow to efficiently and accurately model DAS VSP data using reciprocity.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

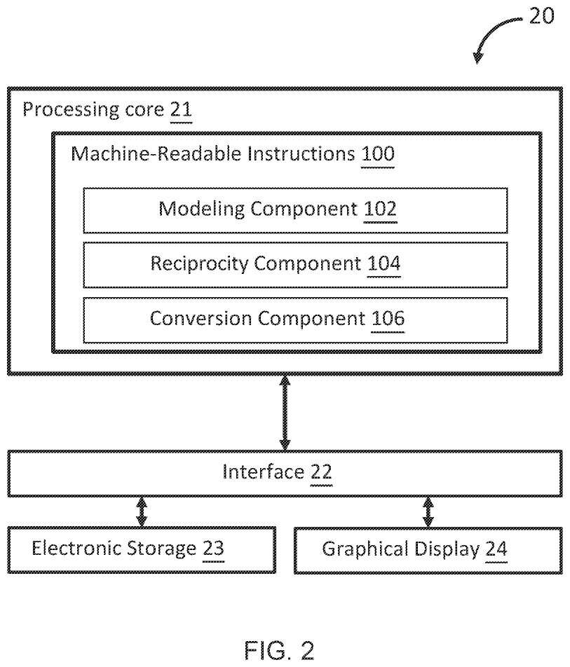

The methods and systems of the present disclosure may be implemented by a system and/or in a system, such as a system 20 shown in FIG. 2. The system 20 may include one or more of a processing core 21, an interface 22 (e.g., bus, wireless interface), an electronic storage 23, a graphical display 24, and/or other components.

The electronic storage 23 may be configured to include electronic storage medium that electronically stores information. The electronic storage 23 may store software algorithms, information determined by the processing core 21, information received remotely, and/or other information that enables the system 20 to function properly. For example, the electronic storage 23 may store information relating to input DAS seismic data, and/or other information. For example, the electronic storage 23 may store information relating to output processed seismic data, seismic images, and/or other information. The electronic storage media of the electronic storage 23 may be provided integrally (i.e., substantially non-removable) with one or more components of the system 20 and/or as removable storage that is connectable to one or more components of the system 20 via, for example, a port (e.g., a USB port, a Firewire port, etc.) or a drive (e.g., a disk drive, etc.). The electronic storage 23 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 23 may include one or more non-transitory computer readable storage medium storing one or more programs. The electronic storage 23 may be a separate component within the system 20, or the electronic storage 23 may be provided integrally with one or more other components of the system 20 (e.g., the processing core 21). Although the electronic storage 23 is shown in FIG. 2 as a single entity, this is for illustrative purposes only. In some implementations, the electronic storage 23 may comprise a plurality of storage units. These storage units may be physically located within the same device, or the electronic storage 23 may represent storage functionality of a plurality of devices operating in coordination.

The graphical display 24 may refer to an electronic device that provides visual presentation of information. The graphical display 24 may include a color display and/or a non-color display. The graphical display 24 may be configured to visually present information. The graphical display 24 may present information using/within one or more graphical user interfaces. For example, the graphical display 24 may present information relating to DAS seismic data and processed seismic data, and/or other information.

The processing core 21 may be configured to provide information processing capabilities in the system 20. As such, the processing core 21 may comprise one or more of a digital processing core, an analog processing core, a digital circuit designed to process information, a central processing unit, a graphics processing unit, a microcontroller, an analog circuit designed to process information, a state machine, and/or other mechanisms for electronically processing information. The processing core 21 may be configured to execute one or more machine-readable instructions 100 to facilitate modeling DAS VSP data. The machine-readable instructions 100 may include one or more computer program components. The machine-readable instructions 100 may include a modeling component 102, a reciprocity component 104, a conversion component 106, and/or other computer program components.

It should be appreciated that although computer program components are illustrated in FIG. 2 as being co-located within a single processing unit, one or more of computer program components may be located remotely from the other computer program components. While computer program components are described as performing or being configured to perform operations, computer program components may comprise instructions which may program processing core 21 and/or system 20 to perform the operation.

While computer program components are described herein as being implemented via processing core 21 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the modeling component 102 may be configured to perform standard seismic data modeling for pressure data.

The reciprocity component 104 may be configured to generate modeled seismic data (pressure field data) using reciprocity.

The conversion component 106 may be configured to convert pressure data to strain-rate measured by DAS.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processing core 21 may be configured to execute one or more additional computer program components that may perform some or all of the functionality attributed to one or more of computer program components described herein.

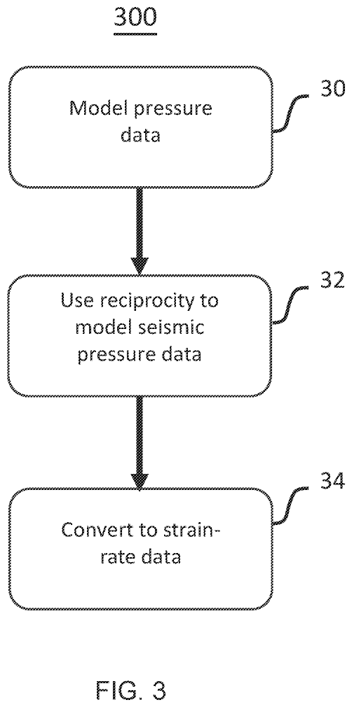

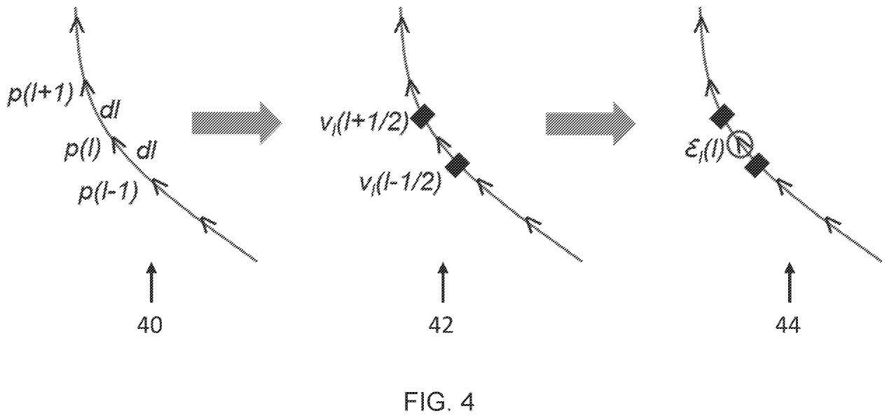

FIG. 3 illustrates an example process 300 for modeling DAS VSP data. At step 30, the method generates synthetic data with a pressure source at the surface and with receivers along a DAS cable in the fluid. This synthetic data is the conventional pressure-field data that is generated by conventional seismic modeling methods such as finite difference modeling (FDM) which simulates seismic wave propagation within the earth, by solving the wave equation using differential method [The pressure-field data is illustrated as example 40 in FIG. 4.

At step 32, the method performs modeling using reciprocity:
1) Sort the vessel data with survey geometry for synthetic generation from shot gathers to receiver gathers as input for finite-difference modeling
2) Select reciprocity for FD modeling to use a receiver as a source and using all sources as receivers with pressure for both the source and receivers to generate synthetic data
3) After all the synthetic data generated from the previous step, sort the data to common shot gathers.

At step 34, the method converts the pressure field of the conventional modeling into a strain-rate field measured by DAS:
1) Take the spatial derivative of pressure (p) in the direction of the cable (l) and do temporal integral to get the particle velocity along the DAS cable vi. (see FIG. 4 example 42)

$${v}_{l} ( l + 1 / 2 ) = \frac{1}{ρ} \int \frac{p ( l + 1 ) - p ( l )}{dl} dt \qquad ( 1 )$$

where ρ is density.
2) Take the spatial derivative of the particle velocity along the cable obtained from the 1^{st} step to get the strain-rate along the DAS cable εₗ (see 44 in FIG. 4) which is the DAS measurement.

$${ε}_{l} ( l ) = \frac{v ( l + 1 / 2 ) - v ( l - 1 / 2 )}{dl} \qquad ( 2 )$$

Following the above workflow steps, especially the step of converting pressure to strain-rate, we get the true DAS measurement using reciprocity. This significantly reduces the computing cost.

Using the method described herein produces more accurate DAS VSP synthetic data, which allows better understanding of appropriate acquisition parameters for field data acquisition. This allows not only superior seismic surveys, but also better survey geometries for time-lapse (4D) seismic monitoring. For example, in 3D/4D DAS VSP surveys, acquisition parameters such as the number of sources and source spacing impact the quality and resolution of subsurface images. Performing seismic modeling on different source geometries to measure the imaging quality of each one of them can help determine an optimum source layout. A well-designed survey with optimized acquisition parameters can improve the accuracy of imaging and reduce uncertainty in subsurface models.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for generating distributed acoustic sensing (DAS) vertical seismic profile (VSP) data, comprising:
a. receiving, at one or more processing cores, synthetic DAS acquisition parameters;
b. modeling, via the one or more processing cores, synthetic pressure-field data;
c. augmenting, via the one or more processing cores, the synthetic pressure-field data using reciprocity to generate an augmented dataset;
d. sorting, via the one or more processing cores, the augmented dataset into pressure-field common shot gathers; and
e. converting, via the one or more processing cores, the pressure-field common shot gathers to strain-rate DAS VSP data.

2. The method of claim 1 wherein the converting comprises:
a. taking a spatial derivative of pressure along a DAS cable;
b. performing a temporal integral to find particle velocity along the DAS cable; and
c. taking a spatial derivative of the partial velocity along the DAS cable to convert the pressure-field common shot gathers to strain-rate DAS VSP data.

3. The method of claim 1 further comprising repeating the steps with different synthetic DAS acquisition parameters in order to compare the strain-rate DAS VSP data so a preferred set of DAS acquisition parameters can be determined and implemented for a real-life survey.

4. A computer system, comprising:
one or more processing cores;
memory; and
one or more programs, wherein the one or more programs are stored in the memory and configured to be executed by the one or more processing cores, the one or more programs including instructions that when executed by the one or more processing cores cause the system to:
a. receive, at the one or more processing cores, synthetic DAS acquisition parameters;
b. model, via the one or more processing cores, synthetic pressure-field data;
c. augment, via the one or more processing cores, the synthetic pressure-field data using reciprocity to generate an augmented dataset;
d. sort, via the one or more processing cores, the augmented dataset into pressure-field common shot gathers; and
e. convert, via the one or more processing cores, the pressure-field common shot gathers to strain-rate DAS VSP data.

5. The system of claim 4 wherein the instructions to convert comprise:
a. taking a spatial derivative of pressure along a DAS cable;
b. performing a temporal integral to find particle velocity along the DAS cable; and
c. taking a spatial derivative of the partial velocity along the DAS cable to convert the pressure-field common shot gathers to strain-rate DAS VSP data.

6. The system of claim 4 further comprising repeating the steps with different synthetic DAS acquisition parameters in order to compare the strain-rate DAS VSP data so a preferred set of DAS acquisition parameters can be determined and implemented for a real-life survey.

7. A non-transitory computer readable storage medium storing one or more programs, the one or more programs comprising instructions, which when executed by an electronic device with one or more processing cores and memory, cause the device to:
a. receive, at the one or more processing cores, synthetic DAS acquisition parameters;
b. model, via the one or more processing cores, synthetic pressure-field data;
c. augment, via the one or more processing cores, the synthetic pressure-field data using reciprocity to generate an augmented dataset;
d. sort, via the one or more processing cores, the augmented dataset into pressure-field common shot gathers; and
e. convert, via the one or more processing cores, the pressure-field common shot gathers to strain-rate DAS VSP data.

8. The non-transitory computer readable storage medium of claim 7 wherein the instructions to convert comprise:
a. taking a spatial derivative of pressure along a DAS cable;
b. performing a temporal integral to find particle velocity along the DAS cable; and
c. taking a spatial derivative of the partial velocity along the DAS cable to convert the pressure-field common shot gathers to strain-rate DAS VSP data.

9. The non-transitory computer readable storage medium of claim 7 further comprising repeating the steps with different synthetic DAS acquisition parameters in order to compare the strain-rate DAS VSP data so a preferred set of DAS acquisition parameters can be determined and implemented for a real-life survey.
